(19) United States
(12) Patent Application Publication
(10) Pub. No.: US 2018/0330871 A1
(43) Pub. Date: Nov. 15, 2018

(54) TRANSFORMER SPACERS

(71) Applicant: ABB Schweiz AG, Baden (CH)

(72) Inventors: Rudi Velthuis, Lauchringen (DE); Manjo Pradhan, Vaesteras (SE); Orlando Girlanda, Vaesteras (SE); Jens Rocks, Baden-Daettwil (SE); Harald Martini, Vasteras (SE); Jan Van Loon, Baden-Daettwil (SE)

(21) Appl. No.: 15/524,218

(22) PCT Filed: Nov. 4, 2015
(86) PCT No.: PCT/IB2015/002184

§ 371 Date: May 3, 2017

Related U.S. Application Data
(60) Provisional application No. 62/075,110, filed on Nov. 4, 2014.

(51) Int. Cl. H01F 27/32; H01F 27/30

(52) U.S. Cl. CPC H01F 27/324; H01F 27/10; H01F 27/306; H01F 27/322

(57) ABSTRACT

An insulation system for an electrical power transformer that includes at least a non-cellulose based axial spacer. The axial spacer may include a pair of spacer arms that extend from a base wall of the axial spacer. Additionally, the spacer arms and the base wall may generally define a hollow inner region of the axial spacer, thereby reducing the volume of the axial spacer. According to certain embodiments, the spacer may include lips that are adapted to lockingly engage a radial spacer. Additionally, at least a portion of the axial spacer and the radial spacer may be constructed from a thermoplastic and/or a thermoset plastic. Further, according to certain embodiments, another portion of the axial spacer, such as, for example, the lips, may be formed from a flexible thermoplastic elastomer or a thermoset elastomer so as to provide the axial spacer with a combination of both flexibility and stiffness.

### CROSS-REFERENCE TO RELATED APPLICATIONS

This application is a U.S. national stage application under 35 U.S.C. § 371 of PCT International Application Serial No. PCT/IB2015/002184, which has an international filing date of Nov. 4, 2015, and claims the benefit of U.S. Provisional Application No. 62/075,110, which was filed on Nov. 4, 2014. The disclosures of each of these prior applications are hereby expressly incorporated by reference in their entirety.

### BACKGROUND

Embodiments of the present invention generally relate to insulation systems for electrical power transformers. More particularly, but not exclusively, embodiments of the present invention relate to non-cellulosed based spacers for insulation systems of electrical power transformers.

Insulation systems in electrical power transformers that utilize a cooling medium, such as, for example, oil filled power transformers, may include axial or radial sticks or spacers. Such spacers may be utilized to separate components of the transformers, such as, for example, coil windings, by a dielectric distance that allows for adequate flow of the cooling medium there between. Traditionally, such spacers have been constructed from a natural and/or engineered cellulose based material, such as, for example, paper or pressboard.

However, the permittivity (ε) of cellulose based materials may be greater than that of the cooling mediums that may flow within the power transformer. For example, the permittivity of pressboard may be about twice as much as that of at least certain cooling mediums, including, for example, mineral oil. More specifically, certain cellulose based materials used in power transformer applications can have a permittivity of around 4.2 at 25 degrees Celsius (° C.), while certain mineral oil liquid coolants used in those same applications can have a permittivity of around 2.2 at 25 degrees Celsius (° C.). Thus, the use of pressboard spacers in insulations system may at least assist in increasing the intensity of the electric field that is present between separated components of the transformer.

Additionally, cellulose based materials may have a moisture content that is approximately 6%-8% by weight. While such insulation materials may be dried during transformer manufacturing, the porous nature of cellulose based materials and associated relatively high moisture uptake characteristics can result in cellulose based materials having a moisture content that can contribute to relatively significant problems over the life of the transformer, including, for example, issues relating to dielectric and thermal characteristics or properties, ageing, bubble formation, and/or unreliability of the insulation system and the associated operation of the power transformer. Moreover, the relatively high moisture uptake sensitivity to high temperatures of cellulose based materials can at least contribute, if not result in, relatively rapid aging of at least cellulose based insulation materials.

Additionally, environmental conditions within the transformer can adversely impact the number of intact chains of cellulose fibers in the cellulose based material, and thereby reduce the structural integrity, size, and/or life expectancy of those cellular based materials. For example, the acidity, oxygen content, and/or temperature of the cooling medium used in the power transformer may impact the ability of cellulose based materials of components of the insulation system to withstand mechanical forces, including, for example, forces associated with through fault. Further, the effects of such environmental conditions, as well as at least aging and gassing, have on cellulose based insulation materials may facilitate a reduction in the size of the separation between adjacent coils and/or the distance between cylinders and coil windings, which may thereby adversely impact the flow of cooling medium there between, potentially lead to axial imbalance of the windings, and increase the propensity for issues relating to short circuit forces.

### BRIEF SUMMARY

An aspect of the present invention is an axial spacer for an electrical power transformer. The axial spacer may include a first spacer arm and a second spacer arm, the first and second spacer arms being adapted to extend from a base wall of the axial spacer. Additionally, the first and second spacer arms and the base wall may generally define a hollow inner region of the axial spacer, the hollow inner region being sized to provide a passageway for the flow of a liquid cooling medium.

Another aspect of the present invention is an insulation system for an electrical power transformer. The insulation system includes at least one radial spacer that is adapted to securely engage the at least one axial spacer. The at least one axial spacer includes a first spacer arm and a second spacer arm, the first and second spacer arms being adapted to extend from a base wall of the at least one axial spacer. Additionally, the first and second spacer arms and the base wall may generally define a hollow inner region of the axial spacer, the hollow inner region being sized to provide a passageway for the flow of a liquid cooling medium. The at least one radial spacer may include a body portion that is adapted to separate a plurality of coil windings of the electrical power transformer by a dielectric distance. Further, at least a portion of the first and second spacer arms are constructed from a non-cellulose base material.

Another aspect of the present invention is an axial spacer for an electrical power transformer. The axial spacer includes a first spacer arm and a second spacer arm. The first and second spacer arms are adapted to extend from a base wall of the axial spacer. Additionally, the first and second spacer arms and the base wall may generally define a hollow inner region of the axial spacer. The axial spacer also includes a first lip and a second lip, the first lip being adapted to extend from the first spacer arm, and the second lip being adapted to extend from the second spacer arm. Additionally, either the first and second lips or the first and second spacer arms are formed from a thermoplastic or a thermoset plastic, and the other of the first and second lips and the first and second spacer arms are formed from a flexible thermoplastic elastomer or a thermoset elastomer.

### BRIEF DESCRIPTION OF THE DRAWINGS

The description herein makes reference to the accompanying figures wherein like reference numerals refer to like parts throughout the several views.

FIG. 1 schematically illustrates a portion of an exemplary electrical power transformer that includes an insulation system having non-cellulose based spacers according to an illustrated embodiment of the present invention.

FIG. 2 illustrates a side perspective view of an axial spacer according to an illustrated embodiment of the present invention.

FIG. 3 illustrates a front view of an axial spacer according to an illustrated embodiment of the present invention.

FIG. 4 illustrates a top perspective view of a radial spacer and a portion of an axial spacer.

FIG. 5 illustrates a side view of an axial spacer according to an illustrated embodiment of the present invention.

FIG. 6 illustrates a top view of an axial spacer and a portion of a radial spacer according to an embodiment of the present invention.

FIG. 7 illustrates a side perspective view of an axial spacer having a lip that is constructed from a thermoplastic material that is different than the material utilized for other portions of the axial spacer.

FIG. 8 illustrates a side perspective view of an axial spacer having opposing lips that are both constructed from a thermoplastic material that is different than a material utilized for other portions of the axial spacer.

FIG. 9 illustrates a schematic of an axial spacer securely engaged with a radial spacer according to an illustrated embodiment of the present invention.

FIG. 10 illustrates a side view of a radial spacer having grooved upper and lower surfaces according to an illustrated embodiment of the present invention.

FIG. 11 illustrates a side perspective view of an axial spacer secured to a cylinder of a power transformer according to an illustrated embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DESCRIPTION OF THE ILLUSTRATED EMBODIMENTS

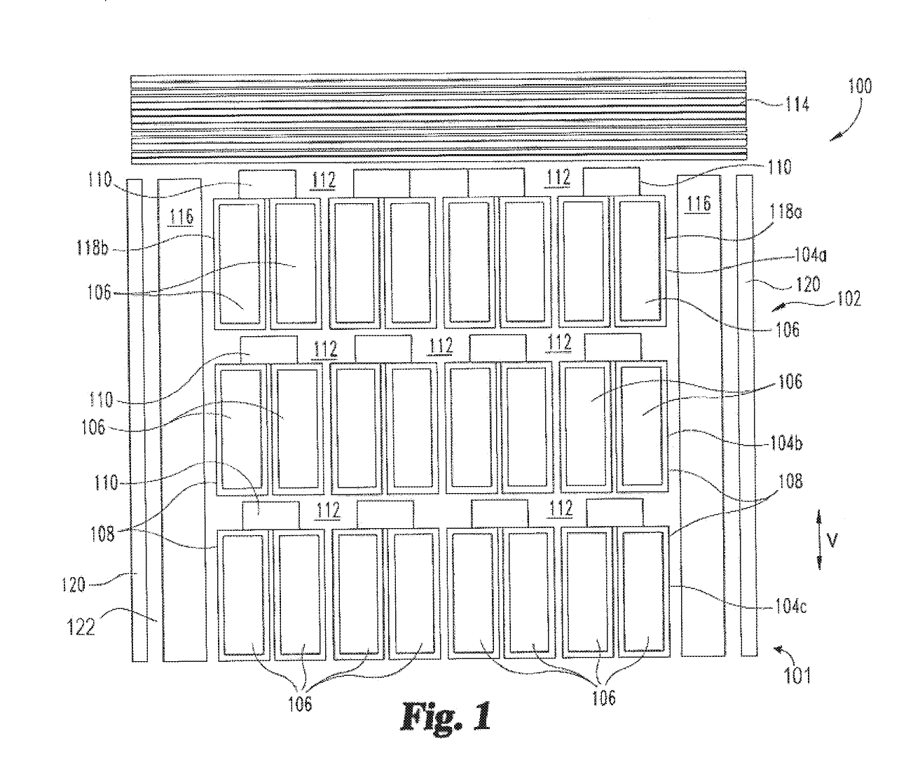

FIG. 1 illustrates a schematic of a portion of an exemplary electrical power transformer 100 that includes an insulation system 102 having non-cellulose based spacers 110, 116 according to an illustrated embodiment of the present invention. The electrical power transformer 100 may be cooled at least in part by a liquid cooling medium. For example, according to certain embodiments, the electrical power transformer 100 may be cooled by, among other coolants, oil or a high temperature dielectric fluid(s), including natural and synthetic esters, as well as silicones and other liquid cooling mediums that can have permittivity that is around the permittivity of non-cellulose based solid insulation materials. For example, according to certain embodiments, the liquid cooling medium can have a permittivity of around 3.2 at 25 degrees Celsius (° C.). The transformer 100 has at least one high voltage winding assembly 101 and at least one low voltage winding assembly (not shown) mounted to a leg of a ferromagnetic core (not shown). The low voltage winding assembly and the high voltage winding assembly 101 are mounted concentrically, with the low voltage winding assembly being disposed radially inward from the high voltage winding assembly 101. The low voltage winding assembly may be separated from the high voltage winding assembly 101 by a cylindrical high/low barrier, which may be composed of a pressboard or polymeric material. If the transformer 100 is a three phase transformer, the transformer 100 will have three low voltage winding assemblies and three high voltage winding assemblies 101 mounted to three core legs, respectively. As shown, each high voltage winding assembly 101 includes a plurality of axially arranged rows 104a-c of disc windings 106, with each row 104a-c having one or more disc windings 106. Each disc winding 106 is formed from one or more turns of an electrical conductor composed of copper or aluminum. Further, in the illustrated embodiment, each of the coil windings 106 may be insulated by an insulation covering 108 that extends around an outer periphery of at least a portion of the coil winding 106. The insulation covering 108 may be constructed from a variety of materials, such as, for example, a non-cellulose based material, such as an enamel coating or a polymeric material, such as Durabil.

Each of the plurality of rows 104a-c of coil windings 106 may be separated from another adjacent layer 104a-c of coil windings 106 by one or more radial spacers 110. For example, as shown in FIG. 1, according to certain embodiments, adjacent layers 104a-c of coil windings 106 may be separated in the vertical direction (as indicated by the “V” direction in FIG. 1) by a plurality of radial spacers 110. The radial spacers 110 may be sized to at least assist in providing a passageway 112 for the flow of the cooling medium at least between the layers 104a-c of coil windings 106. The radial spacers 110 may be constructed from a variety of non-cellulose based materials, such as, for example, a thermoplastic or thermoset plastic. Moreover, according to certain embodiments, the radial spacers 110 may be constructed from, a generally non-porous and/or relatively impermeable material(s). For example, according to certain embodiments, the radial spacers 110 may be constructed from a non-cellulose based material that is essentially non-porous, including, for example, materials that are generally devoid of openings (e.g., holes, channels, cracks, and the like) that could allow liquid to penetrate into or through the material and/or devoid of pores having a size large enough to be subject to the risk of partial discharge into any such pores. Further, according to certain embodiments, the radial spacer 110 may be constructed from a generally non-porous material in that the material has relatively, if any, moisture uptake characteristics, such as, for example, is a material having a maximum moisture content of less than 0.5% by weight at 23° C. and 50% relative humidity.

Additionally, the radial spacers 110 may also be employed to separate one or more of the layers 104a-c of windings 106 from other components of the transformer 100 and/or insulation system 102, such as, for example, pressure rings and/or winding tables 114.

The insulation system 102 may also include one or more axial spacers or sticks 116 that generally extend axially along inner and outer side portions 118a, 118b of the layers 104a-c of coil windings 106. Such axial spacers 116 may at least separate the outer and inner most coil windings 106 in each layer 104a-c from a cylinder 120 disposed around the high voltage winding assembly 101. Moreover, the axial spacers 116 may be employed to provide a passageway 122 for the flow of the cooling medium at least between the layers 104a-c of coil windings 106 and the cylinder 120. The axial spacers 116 may be constructed from a variety of different materials, including, for example, a thermoplastic or thermoset plastic, including, for example, polyetherimid (PEI) or Ultem™. Similarly, the cylinder 120 can also be constructed from a variety of materials, including, but not limited, to thermoplastic, thermoset plastic, non-cellulose based materials, or cellulose based materials, such as, for example, pressboard.

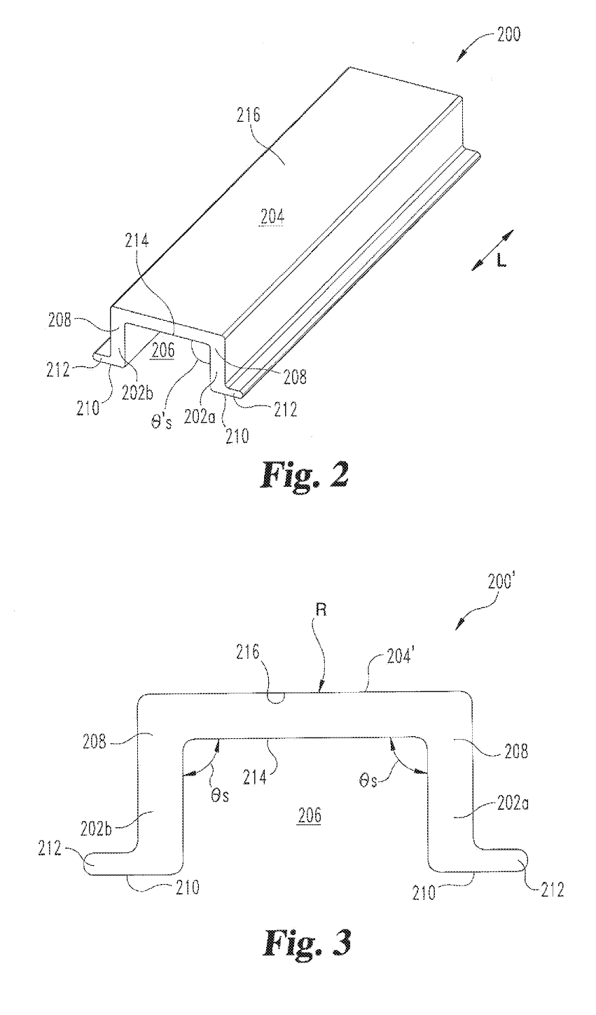

FIGS. 2 and 3 illustrate a side perspective view and side view, respectively, of an axial spacer 200 according to illustrated embodiments of the present invention. As shown, the axial spacer 200 may be constructed, molded, and/or extruded from one or more non-cellulose based materials, such as, for example, a thermoplastic or thermoset plastic, among other materials. For example, according to certain embodiments, the axial spacer 200 may be constructed from a thermoplastic or thermoset plastic that has a level of permittivity (8) that is lower than the permittivity (e) level of cellulose based materials. Moreover, according to certain embodiments, the permittivity of one or more of the material(s) used in the construction of the axial spacer 200 may be around, or around a similar range of, the permittivity of the liquid cooling medium that is used to cool the associated transformer 100. For example, according to certain embodiments, one of more of the material(s) used in the construction of the axial spacer 200 and the liquid cooling medium can both have a permittivity around, or in the range of, 3.2 at 25 degrees Celsius (° C.). According to the embodiment shown in FIG. 2, the axial spacer 200 may include opposing spacer arms 202a, 202b and a base wall 204 that generally define a hollow inner region 206 of the axial spacer 200. According to certain embodiments, the hollow inner region 206 may have a width between the opposing spacer arms 202a, 202b that is adapted to separate the spacer arms 202a, 202b by a distance that allows the spacer arms 202a, 202b to securely engage a radial spacer 300, as discussed below. Further, the inclusion of a hollow inner region 206 of the axial spacer 200 may allow the axial spacer 200 to have a lower volume than traditional axial spacers, thereby allowing for reduced permittivity per volume. Moreover, a reduction in the volume of the axial spacer 200 may allow for an increase in the volume of the cooling medium used to cool the transformer 100 and thus improved cooling of the transformer 100 due to an enhanced flow of the cooling medium. Additionally, the construction of the axial spacer 200 from a non cellulose material, such as a thermoplastic or thermoset plastic, may improve the ability of the axial spacer 200 to withstand exposure to higher operating transformer 100 temperatures, thereby reducing potential damage to the axial spacer 200 associated with overloading of the transformer 100. For example, according to certain embodiments, the thermoplastic or thermoset plastic may have a thermal rating of around 130° Celsius or higher.

The spacer arms 202a, 202b have a proximal end 208 and a distal end 210, with the spacer arms 202a, 202b being joined or otherwise fixed to the base wall 204 at or around the proximal end 208. According to the illustrated embodiment, the spacer arms 202a, 202b may extend from the base wall 204 at a variety of different spacer arm angles (θₛ). For example, in the embodiment illustrated in at least FIG. 2, the spacer arm angles (θₛ) may be generally approximately 90 degrees so that the spacer arms 202a, 202b may be generally perpendicular to the base wall 204. However, as shown below, the spacer arms 202a, 202b may extend away from the base wall 204 at variety of other angles. Additionally, although FIG. 2 illustrates the union of the spacer arms 202a, 202b and the base wall 204 generally occurring at relatively sharp corners, according to other embodiments, a curved or rounded transitional area may be positioned between, or be part of, the transition from the spacer arms 202a, 202b to the base wall 204.

Further, according to certain embodiments, as shown in FIG. 2, the spacer arms 202a, 202b may also include a lip 212a, 212b that may extend away from the distal end 210 of the spacer arms 202a, 202b, respectively. While FIG. 2 illustrates the lips 212a, 212b as extending along the entire length (as indicated by “L” in FIG. 2) of the spacer arms 202a, 202b, according to other embodiments, the lips 212a, 212b may extend along only portions or regions of the spacer arms 202a, 202b, such as, for example, around areas or regions in which the axial spacer 202 is to be engaged by radial spacers 110.

The base wall 204 of the axial spacer 200 may have a variety of shapes and configurations. For example, according to certain embodiments, at least the inner and outer walls 214, 216 of the base wall 204 may be generally parallel to each other, and may each be generally flat. However, as shown in FIG. 3, according to other embodiments, at least the outer wall 216 of the base wall 204 may be formed, such as, for example, by molding or extrusion, to include a curved or arched surface. According to such embodiments, the curvature of the outer wall 216 may be approximately the same as the radius of the cylinder 120 against which the axial spacer 200 may abut. For example, according to certain embodiments, if the radius of the cylinder 120 is approximately 400 to 650 millimeters (mm), the radius of the outer wall 216 may be approximately 650 millimeters (mm). However, according to other embodiments, the radius of the outer wall 216 may be approximately the same as the radius of the cylinder 120. For example, if the cylinder 120 has a radius of about 400 millimeters (mm), the radius of the outer wall 216 may also be about 400 millimeters (mm). Further, according to certain embodiments, the inner wall 214 may also have a curvature that is similar to the curvature of the outer wall 216.

Referencing FIGS. 2-4, at least a portion of the spacer arms 202a, 202b may be adapted to be at least partially bent, deformed, and/or deflected at least when being operably secured to a radial spacer 300. For example, according to certain embodiments, the axial spacer 200 may be extruded or molded from a thermoplastic having sufficient ductility to enable at least partial displacement and/or bending of at least a portion of the spacer arms 202a, 202b when the axial spacer 200 is at least being connected to, or otherwise operably engaged by, a radial spacer 300. Further, according to certain embodiments, at least a portion of the thickness of the spacer arms 202a, 202b at the proximal end 208 may be sized so as to accommodate at least a degree of displacement, deflection, and/or bending of the spacer arms 202a, 202b by the operable engagement of the spacer arms 202a, 202b with the radial spacer 300 without fracturing or cracking. For example, according to certain embodiments, at least a portion of the axial spacer 200 may be constructed from a non-cellulose based material and/or dimensioned such that at least a portion of the axial spacer can be deformed from first shape to a second shape so as to accommodate secure engagement of the axial spacer 200 with another spacer, including, but not limited to, the radial spacer 300. Further, according to certain embodiments, such deformation may be include an orientation of at least a portion of the axial spacer 200 relative to another portion of the axial spacer being adjusted, including, for example the spacer arms 202a, 202b being bent, deformed, or otherwise displaced relative to the orientation of the base wall 204. Additionally, such deformation or changes in orientation of at least a portion of the axial spacer 200 may accommodate the selective engagement of the axial spacer 200 with at least other spacers, including at least temporarily deforming or changing the shape of the axial spacer 200 so that the axial spacer 200 can be displaced into, as well as removed from, engagement with other spacers, including, for example, one or more radial spacers 300.

One or more of the spacer arms 202a, 202b and/or one or more of the lips 212a, 212b of the axial spacer 200 may be composed of a flexible thermoplastic elastomer (TPE) or flexible thermoset elastomer, while the base wall 204 and/or one or more of the spacer arms 202a, 202b may be composed of a more rigid thermoplastic or thermoset plastic. For example, in one embodiment, one or more of the lips 212a, 212b is composed of a flexible elastomer, while the base wall 204 and the spacer arms 202a, 202b are composed of a more rigid plastic.

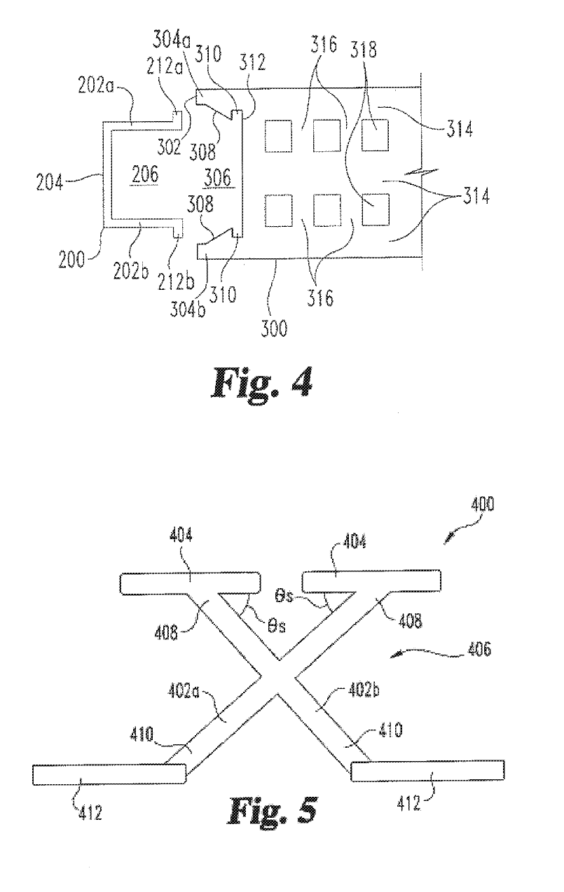

FIG. 4 illustrates a top perspective view of a radial spacer 300 and a portion of an axial spacer 200 according to an illustrated embodiment of the present invention. As illustrated, a first end 302 of the radial spacer 300 includes a pair of clamping arms 304a, 304b that are separated by a recess 306 in the radial spacer 300. According to the illustrated embodiment, each clamping arm 304a, 304b includes a tapered sidewall 308, a cavity 310, and a back wall 312. When the radial spacer 300 is to be secured to the axial spacer 200, at least the distal end 210 of the spacer arms 202a, 202b may enter into the recess 306 of the radial spacer 300. As the axial spacer 200 and/or radial spacer 300 is displaced such that the distance between the axial spacer 200 and a second, end side 314 of the radial spacer 300 is reduced, the distal end 210 and/or the lips 212a, 212b contact the adjacent tapered sidewall 308. The tapered sidewalls 308 may be inwardly angled or inclined such that distance separating the tapered sidewalls 308 decreases the further the radial spacer 300 is displaced into the recess 306. The engagement between the lips 212a, 212b of the axial spacer 200 and the tapered sidewalls 308 may cause the spacer arms 202a, 202b to be displaced, bent, and/or deformed toward each other until the lips 212a, 212b are received in the adjacent cavity 310. Moreover, the cavity 310 may have a depth that generally extends outwardly away from the recess 306 to a degree that allows the lips to be secured in the cavity 310 between the tapered sidewalls 308 and the back wall 312. Accordingly, efforts to release the lips 212a, 212b from the cavities 310 may involve depressing, deforming, and/or bending the spacer arms 202a, 202b so as to release the lips 212a, 212b from the cavities 310 and to an extent to which the distance separating at least the outer ends of the lips 212a, 212b is less than the distance separating opposing portions of the tapered sidewalls 308 that are adjacent to the cavities 310.

As illustrated in FIG. 4, the radial spacer 300 may have a plurality of orifices 318 extending therethrough. The orifices 318 may be defined by a plurality of support elements 316. For example, in the illustrated embodiment, the support elements 316 are a plurality of cross bars that may be arranged to separate coil windings 106 in separate layers 104a-c of coil windings 106 by a dielectric distance. Additionally, according to certain embodiments, the support elements 316 may provide structural support to the layers of coil windings 106, such as, for example, support to withstand mechanical forces associated with through fault. Additionally, the orifices 318 are adapted to facilitate the flow of cooling medium between the layers 104a-c of coil windings 106. Further, the inclusion of orifices 318 can reduce the volume of the radial spacer 300, such as, for example, at least contribute to the radial spacer 300 having a volume that is lower than the volume of traditional radial spacers, and thereby allow for reduced permittivity per volume. Additionally, reducing the volume of the radial spacer 300 can result in an increase in the volume of the liquid cooling medium that cools the transformer 100, which can enhance the flow of cooling medium and thereby improve the cooling of the transformer 100.

The non-cellulose based axial spacers 200 may have a variety of different configurations. For example, similar to the axial spacer 200 configuration depicted in at least FIG. 2, the axial spacer 400 illustrated in FIG. 5 may also have a lower volume than at least traditional axial spacers, while also maintaining the structural integrity of the axial spacer 400. The axial spacer 400 depicted in FIG. 5 may attain a reduction in volume by utilizing a configuration in which the spacer arms 402a, 402b, at the proximal end 408, extend from a base wall 404 at a spacer arm angle (θₛ) that allows the spacer arms 402a, 402b to intersect, and extend beyond the intersection, in an inner region 406 of the axial spacer 400. For example, according to such embodiments, the spacer arm angle (θₛ) that is greater than 0 degrees and less than 90 degrees, and more specifically is around 30 degrees to 50 degrees. Moreover, in the embodiment illustrated in FIG. 5, the spacer arm angle (θₛ) is around 45 degrees. Additionally, with the exception of the intersecting spacer arms 402a, 402b, the inner region 406 between the base wall 404 and the lips 412 may generally be hollow.

Additionally, as shown by FIG. 5, the lips 412 at the distal end 410 of the spacer arms 402a, 402b may continue to outwardly extend away from the axial spacer 400 in a manner similar to that discussed above with respect to the embodiment of the axial spacer 200 depicted in at least FIG. 2. Further, the spacer arms 402a, 402b and the outwardly extending portion of the lips 412 may also be adapted for the lips 412 to be received in the cavity 310 or other mating structure of the radial spacer 300, as previously discussed, among other radial spacers. Accordingly, the spacer arms 402a, 402b may be configured to bend, deform, and/or deflect in a manner similar to that described above with respect to FIG. 2 that allows the axial spacer 400 to be securely engaged with a mating radial spacer 300.

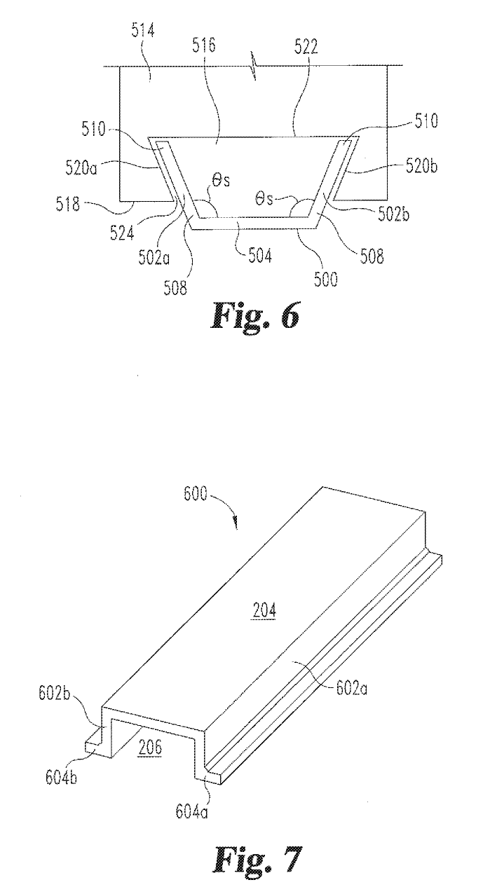

FIG. 6 illustrates another embodiment of a non-cellulose based axial spacer 500 and a portion of a mating radial spacer 514. As shown, the axial spacer 500 may generally have a trapezoidal or “V” shape in which the spacer arm angle (θₛ) at which the spacer arms 502a, 502b extend away from the base wall 504 is greater than 90 degrees, and in which the inner region 506 between the spacer arms 502a, 502b and base wall 504 is generally hollow. According to certain embodiments, the spacer arms 502a, 502b may not include lips. Thus, rather than using the lips to securely engage the axial and radial spacers 500, the axial spacers 500 may be secured within an aperture 516 at an adjacent end 518 of the radial spacer 514. For example, the aperture 516 may include tapered sidewalls 520a, 520b that generally conform to the angular orientation of the spacer arms 502a, 502b. Therefore, as shown by at least FIG. 6, the distance between the distal ends 510 of opposing spacer arms 502a, 502b is similar to the distance between opposing tapered sidewalls 520a, 520b at or near an end wall 522 of the aperture 516, and the smaller distance between the proximal ends 508 of opposing spacer arms 502a, 502b is similar to that distance between opposing tapered sidewalls 520a, 520b at or near a mouth portion 524 of the aperture 516. Accordingly, as the distance between opposing tapered sidewalls 520a, 520b at the mouth portion 524 is smaller than distance between opposing spacer arms 502a, 502b as the opposing spacer arms 502a, 502b extend away from the proximal ends 508 of the spacer arms 502a, 502b, the axial spacer 500 cannot be inserted into, or removed from, the aperture 516 through the mouth portion 524. Moreover, such differences in sizes may at least assist in retaining the axial spacer 500 in the aperture 516. Thus, according to such embodiments, the axial spacer 500 may be vertically inserted or slide into the aperture 516.

One or more of the spacer arms 502a, 502b may be composed of a flexible thermoplastic elastomer (TPE) or flexible thermoset elastomer, while the base wall 504 may be composed of a more rigid thermoplastic or thermoset plastic.

The ability to vertically insert or remove axial spacers 500 into/from the apertures 516 of radial spacers 514 while still being able to achieve a secure engagement there between may allow for axial spacers 500 and/or radial spacers 514 to be added or removed during manufacturing of the power transformer 100, including during winding of the coil(s). Further, such a configuration may allow for the use of relatively rigid or stiff thermoplastic materials for the radial spacers 514 and/or axial spacers 500, as the axial spacer 500 may be slid into and out from a secured engagement with the apertures 516 of various radial spacers 514 with minimal, if any, bending or deforming, if the axial and radial spacers 500, 514.

As previously discussed, the axial spacers 116, 200, 400, 500 and/or radial spacers 110, 300, 514 may be constructed from a non-cellulose based material, such as, for example, a thermoplastic or thermoset plastic, among other materials. Further, according to certain embodiments, the axial spacers 116, 200, 400, 500 and/or radial spacers 110, 300, 514 may be constructed from a material that has a permittivity that is generally the same, or around the same range, as the permittivity of the liquid cooling medium that may be used to cool the transformer 100. Additionally, according to certain embodiments, the radial spacers 110, 300, 514 may also be constructed from a generally non-porous or impermeable material(s), as previously discussed above with respect to the radial spacers.

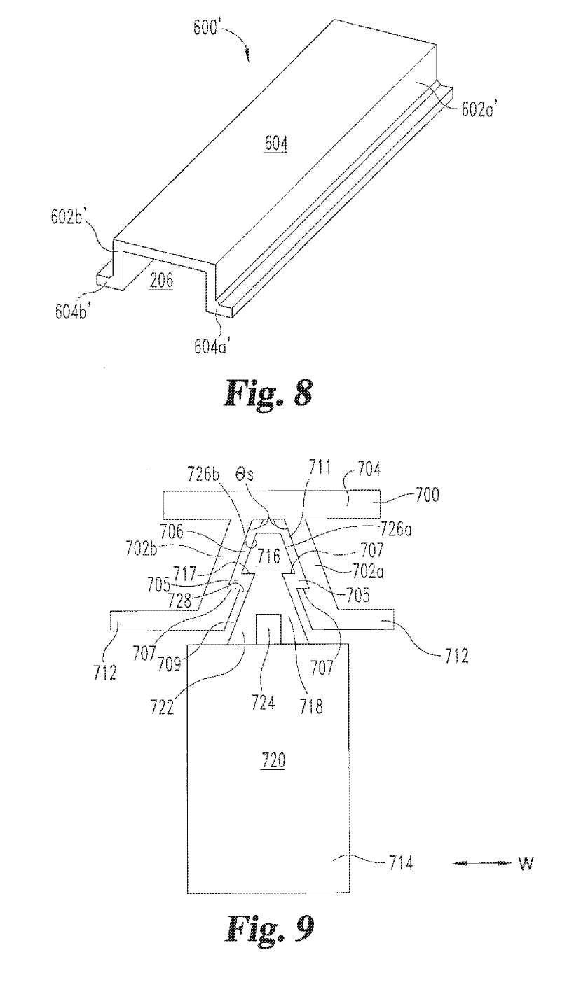

According to certain embodiments, the axial spacers 116, 200, 400, 500 and/or radial spacers 110, 300, 514 may be constructed from a combination of non-cellular based materials that have different properties or characteristics. For example, FIG. 7 illustrates an embodiment of the present invention in which a lip 604a of at least one spacer arm 602a of an axial spacer 600 is a relatively flexible thermoplastic elastomer (TPE) or thermoset elastomer, such as, for example, nitrile rubber (NBR) or hydrogenated nitrile butadiene rubber (HNBR), among other materials, while other portions of the axial spacer 600, such as, for example, the opposing spacer arm 602b and associated lip 604b are formed from a relatively stiffer type of thermoplastic or thermoset plastic. Similarly, FIG. 8 illustrates an embodiment of an axial spacer 600′ in which both lips 604a′, 604b′ are formed from a flexible thermoplastic elastomer (TPE), while the spacer arms 602a′, 602b′ and base wall 604 are formed from a relatively stiffer thermoplastic. Such differences in at least flexibility of the materials may assist in operably engaging at least the lips 604a, 604a′, 604b′, as well as other components of the axial spacers 600, 600′, with the corresponding radial spacer 300 or other components of the insulation system 102 while still allowing the axial spacer 600, 600′ to retain a degree of stiffness. For example, with respect to the radial spacer 300 shown in FIG. 4, enhancing the flexibility of the lips 604a, 604a′, 604b′, such as by using a flexible thermoplastic elastomer (TPE), may reduce the force that would otherwise be exerted on the lips 604a, 604b, 604a′, 604b′ as the lips 604a, 604b, 604a′, 604b′ are brought into closer proximity to the corresponding cavities 310. Further, the increased flexibility of the lips 604a, 604a′, 604b′ may reduce the degree to which the spacer arms 602a, 602b, 602a′, 602b′ are displaced, bent, and/or deformed at least when the axial spacer 600, 600′ is being secured to the radial spacer 300, thereby both reducing the force asserted upon, and the associated risk of fracturing, the spacer arms 602a, 602b, 602a′, 602b′.

Various portions of the axial spacer 600, 600′ in addition to, or in lieu of, the lips 604a, 604a′, 604b′ may be construed from a relatively flexible thermoplastic elastomer (TPE) or flexible thermoset elastomer. For example, the spacer arms 602a, 602b, 602a′, 602b′ of the axial spacer 600, 600′ illustrated in FIGS. 7 and 8, among other embodiments or configurations of axial spacers, may be a flexible thermoplastic elastomer (TPE) or flexible thermoset elastomer, while the base wall 604 and/or lips 604a, 604b, 604a′, 604b′ are formed from a more rigid thermoplastic or thermoset plastic.

Axial spacers 600, 600′ that are formed from different materials may be manufactured in a number of manners, including for example, via extrusion or molding. For example, according to certain embodiments, the axial spacers 600, 600′ may be co-extruded, with one material, such as the flexible thermoplastic elastomer, being extruded on another extruded material, such as on the thermoplastic. Alternatively, the axial spacers 600, 600′ may be formed via injection molded, such as, for example, by a relatively stiff thermoplastic material being injection molded and transferred to another mold, wherein a relatively softer thermoplastic elastomer portion(s) of the axial spacer 600, 600′ is molded.

FIG. 9 illustrates a schematic of an axial spacer 700 securely engaged with a radial spacer 714 according to an illustrated embodiment of the present invention. As shown, both spacer arms 702a, 702b of the axial spacer 700 may outwardly extend from the base wall 704 in opposing directions at a spacer arm angle (θₛ) that is greater than 90 degrees. Further, the spacer arms 702a, 702b may each include a recessed portion 705 that is adapted to provide undercuts 707 that at least assist in retaining a secure engagement with the radial spacer 714. Additionally, the base wall 704 and shape and orientation of the spacer arms 702a, 702b may generally define a hollow inner region 706 having a first section 709 and a second section 711. According to the illustrated embodiment, the first and second sections 709, 711 may have generally trapezoidal configurations.

The radial spacer 714 may include a trapezoidal shaped tip 716 that extends via a tapered extension arm 718 from a body portion 720 of the radial spacer 714. The trapezoidal shape of the tip 716 may include rear abutment surfaces 717 that generally extend outwardly from the tip 716 to a distance that is wider than the adjacent portion of the extension arm 718. Additionally, according to certain embodiments, at least a portion of the tip 716 may be a relatively flexible thermoplastic elastomer (TPE) or thermoset elastomer, which may improve the ease at which the radial spacer 714 and axial spacer 700 may be assembled together. For example, as shown in FIG. 9, an outer portion 722 of the tip 716 and extension arm 718 may be constructed from a relatively flexible thermoplastic elastomer (TPE), while an inner portion 724 of the extension arm is constructed from a more rigid thermoplastic. However, according to other embodiments, at least a portion of the spacer arms 702a, 702b may be constructed from a flexible thermoplastic elastomer (TPE) or thermoset elastomer.

During assembly, as the distance between the tip 716 and the base wall 704 is decreased, the tip 716 may pass from the first section 709 of the inner region 706 to the second region 711 of the inner region 706. As the tip 716 passes along the first section 709, the angled sidewalls 726a, 726b of the trapezoidal shaped tip 716 may engage the adjacent angled spacer arms 702a, 702b in a manner that bends, deflects, and/or deforms the angled spacer arms 702a, 702b away from each other and/or which compresses or otherwise deforms the tip 716. The distance the angled spacer arms 702a, 702b may be separated from each other and/or the degree to which the tip 716 is compressed or deformed may increase as the abutment surfaces 717 of the tip 716 approach and/or reach the relatively narrower mouth portion 728 of the second section 711. The passage of the abutment surfaces 717 of the tip 716 through the mouth portion 728 and into the second region 711 may release the engagement between the sidewalls 726a, 726b of the tip 716 and at least the portion of the spacer arms 702a, 702b that define the first section 709. The second section 711 may generally be sized such that, when the tip 716 is operably received in the second section 711, the undercuts 707 in the spacer arms 702a, 702b are positioned to prevent the tip 716 for being displaced back to the first section 709. Moreover, the positioning of the undercuts 707, and well as the configuration of the abutment surfaces 717, may create a barrier or interference that prevents the withdrawal of the tip 716 from the second section 711.

Further, as shown in FIG. 9, according to certain embodiments, at least the lips 712 of the axial spacer 700 may extend outwardly (in the “W” direction as indicated in FIG. 9) to a distance that provides the axial spacer 700 with a width that is larger than the corresponding width of the body portion 720 of the radial spacer 714. Such differences in widths between the axial spacer 700 and the radial spacer 714 may increase the electrical creepage distance.

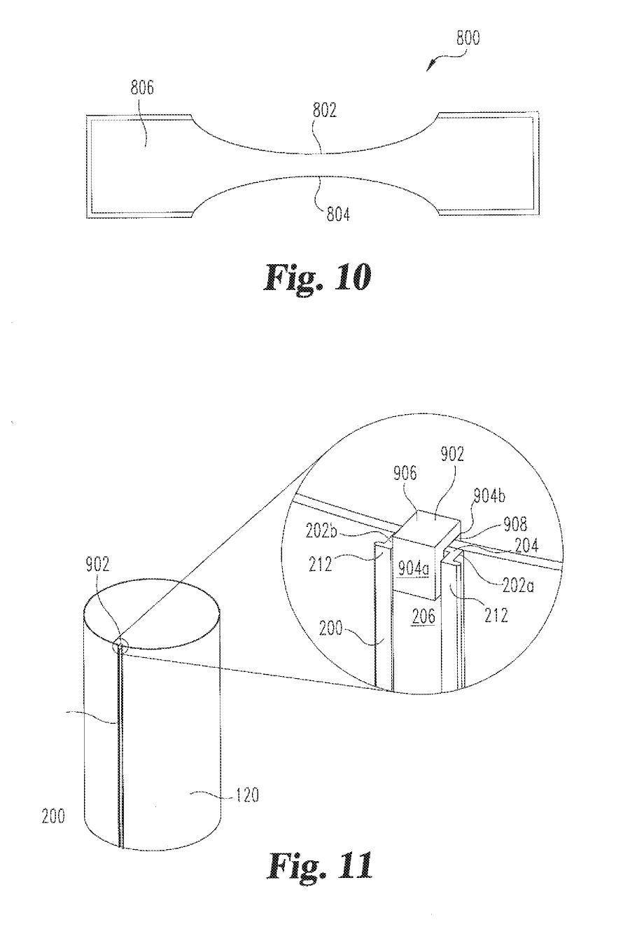

Although the body portion 720 of the radial spacer 714 in the general representation shown in FIG. 9 is rectangular in shape, the body portion 720 may have a variety of other shapes and sizes. For example, FIG. 10 illustrates a side view of a radial spacer 800 according to an illustrated embodiment of the present invention in which the upper and bottom surfaces 802, 804 of at least a portion of the body portion 806 may each provide at least one horizontal groove that may enhance the flow of cooling medium, and thus further facilitate the cooling of hot spot temperatures of the windings 106. Additionally, as previously discussed, and as shown in FIG. 4, according to certain embodiments, the radial spacer 300 may include a plurality of orifices 318 that may also facilitate the flow of the cooling medium to cool the coil windings 106. Further, as previously discussed, the inclusion of orifices 318 can reduce the volume of the radial spacer 300, and thereby allow for a reduced permittivity per volume, which can contribute to an increase in the volume of the liquid cooling medium that flows in the transformer 100, and thereby improve the cooling of the transformer 100.

The axial spacers 116, 200, 400, 500, 600, 600′, 700 may at least be temporarily secured or coupled to the cylinder 120 in a variety of different manners. For example, FIG. 11 illustrates an axial spacer 200 being secured to a cylinder 120 by a clip 902. The clip 902 may be employed to couple the axial spacer 200 to the cylinder 120 at least until the coils are wound in the transformer 100 to an extent in which the engagement of the axial spacer 200 with the coil windings 106 or other components of the insulation system 102, such as radial spacers 300, 514, 714, 800, will maintain the axial spacer 200 in a relatively static position. As shown, the clip 902 may be a generally “U” shaped bracket that has a pair of opposing sidewalls 904a, 904b and a top wall 906 that generally define a clip recess 908 there between that is sized to at least receive placement of the axial spacer 200 and the cylinder 120. According to certain embodiments, the clip recess 908 may be sized to exert a compressive or clamping force on the base wall 204 of the axial spacer 200 and the cylinder 120 so as to at least assist in maintaining the axial spacer 200 in a relatively static position. Although the clip 902 in FIG. 11 is illustrated as a monolithic structure, according to other embodiments, the clip 902 may be comprised of a plurality of separate pieces. For example, the sidewalls 904a, 904b may be part of separate components that are joined together or about at the top wall 906, such as, for example, by a snap fit, so that the clip recess 908 may be formed around the base wall 204 and the cylinder 120. Alternatively, rather that utilizing a clip 902, according to other embodiments, the axial spacer 200 and the cylinder 120 may at least temporarily be coupled together by a wedge.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

1. An axial spacer for an liquid cooled electrical power transformer, the axial spacer comprising:
a first spacer arm and a second spacer arm, the first and second spacer arms extending from a base wall of the axial spacer, the first and second spacer arms and the base wall generally defining a hollow inner region of the axial spacer, the hollow inner region axially extending along a length of the base wall and sized to provide a passageway for the flow of a liquid cooling medium, and wherein at least a portion of the first and second spacer arms are constructed from a non-cellulose based material, at least a portion of the axial spacer being deformable from at least a first shape to a second shape to facilitate the axial spacer being selectively, and removably, engaged with another spacer.

2. The axial spacer of claim 1, wherein the non-cellulose based material is at least one of a thermoplastic or a thermoset plastic.

3. The axial spacer of claim 2, wherein the first and second spacer arms are generally perpendicular to the base wall.

4. The axial spacer of claim 3, wherein the first spacer arm includes a first lip, and the second spacer arm includes a second lip, the first lip extending from a distal end of the first spacer arm, the second lip extending from a distal end of the second spacer arm.

5. The axial spacer of claim 4, wherein the first and second lips are generally parallel to the base wall.

6. The axial spacer of claim 4, wherein the base wall includes an inner wall and an outer wall, the inner and outer walls being on opposing sides of the base wall, the inner wall being adjacent to the hollow inner region, and wherein the outer wall is a curved surface.

7. The axial spacer of claim 4, wherein at least one of the first and second lips are formed from a flexible thermoplastic elastomer or a thermoset elastomer.

8. The axial spacer of claim 2, wherein the first spacer arm intersects the second spacer arm in the hollow inner region.

9. The axial spacer of claim 8, wherein the first spacer arm includes a first lip, and the second spacer arm includes a second lip, the first lip extending from a distal end of the first spacer arm, the second lip extending from a distal end of the second spacer arm.

10. The axial spacer of claim 2, wherein the first and second spacer arms each extend from the base wall at a spacer arm angle, the spacer arm angle being greater than 90 degrees.

11. The axial spacer of claim 1, wherein the non-cellulose based material of the first and second spacer arms is different than a material of at least the base wall.

12. The axial spacer of claim 1, further including one or more orifices extending through the axial spacer, the one or more orifices sized to reduce a permittivity per volume level of the axial spacer.

13. The axial spacer of claim 1, wherein the non-cellulose based material has a maximum moisture content of less than 0.5% by weight at 23° C. and 50% relative humidity.

14. An insulation system for a liquid cooled electrical power transformer, the insulation system including:
at least one axial spacer, the at least one axial spacer having a first spacer arm and a second spacer arm, the first and second spacer arms extending from a base wall of the at least one axial spacer, the first and second spacer arms and the base wall generally defining a hollow inner region along an axial length of the axial spacer, the hollow inner region sized to provide a passageway for the flow of a liquid cooling medium, and wherein at least a portion of the first and second spacer arms are constructed from a non-cellulose based material; and
at least one radial spacer, the at least one radial spacer having a body portion adapted to separate a plurality of coil windings of the electrical power transformer by a dielectric distance, the at least one radial spacer adapted to securely engage the at least one axial spacer,
wherein the at least a portion of the at least one axial spacer and the at least one radial spacer are constructed from at least one of a thermoplastic and a thermoset plastic, and wherein the first and second spacer arms of the at least one axial spacer are deformable from a first orientation to a second orientation to facilitate the at least one axial spacer being selectively securely engaged with the at least one radial spacer.

15. The insulation system of claim 14, wherein the first spacer arm includes a first lip, and the second spacer arm includes a second lip, and wherein the at least one radial spacer includes a first clamping arm and a second clamping arm, the first and second clamping arms adapted to displace the first and second spacer arms as the at least one axial spacer is being secured to the at least one radial spacer.

16. The insulation system of claim 15, wherein the insertion of the first lip in a first cavity of the at least one radial spacer and the insertion of the second lip in a second cavity of the at least one radial spacer lockingly secures the at least one axial spacer to the at least one radial spacer.

17. The insulation system of claim 16, wherein at least a portion of at least one of the first and second lips are formed from a flexible thermoplastic elastomer or a thermoset elastomer.

18. The insulation system of claim 15, wherein the first and second spacer arms each extend from the base wall at a spacer arm angle, the spacer arm angle being greater than 90 degrees, and wherein the at least one radial spacer includes an aperture adapted to receive slideable insertion of the first and second spacer arms, the aperture having a mouth portion at a first end of the at least one radial spacer, the mouth portion having a width that is narrower than a distance between a distal end of the first spacer arm and a distal end of the second spacer arm.

19. The insulation system of claim 14, wherein the at least one radial spacer includes a tip having a generally trapezoidal shape that is adapted for locking insertion into a trapezoidal shaped area of the hollow inner region.

20. The insulation system of claim 19, wherein at least a portion of the tip is formed from a flexible thermoplastic elastomer or a thermoset elastomer.

21. The insulation system of claim 14, wherein the at least one radial spacer has an upper surface and a bottom surface, the upper and bottom surfaces both having at least one horizontal groove that is adapted to facilitate the flow of a cooling medium of the electrical power transformer to hot spot temperatures of one or more coil windings of the electrical power transformer.

22. The insulation system of claim 14, further including a clip adapted to retain the at least one axial spacer against a cylinder of the insulation system, the clip having a pair of opposing sidewalls that generally define a clip recess, the clip recess adapted to receive insertion of at least a portion of the base wall of the at least one axial spacer and a portion of the cylinder, at least one of the opposing sidewalls configured to be received in the hollow inner region.

23. The insulation system of claim 14, wherein the non-cellulose based material of the first and second spacer arms is different than a material of at least the base wall.

24. The insulation system of claim 14, wherein at least a portion of at least one of the at least one axial spacer and the at least one radial spacer is constructed from a non-cellulose based material having a permittivity that is similar to a permittivity of a liquid cooling medium of the liquid cooled electrical power transformer.

25. An axial spacer for an electrical power transformer, the axial spacer comprising:
a first spacer arm and a second spacer arm, the first and second spacer arms extending from a base wall of the axial spacer, the first and second spacer arms and the base wall generally defining a hollow inner region along an axial length of the axial spacer, the axial spacer further including a first lip and a second lip, the first lip extending from the first spacer arm, the second lip extending from the second spacer arm.

26. The axial spacer of claim 25, wherein either the first and second lips or the first and second spacer arms are formed from a thermoplastic or a thermoset plastic, and the other of the first and second lips and the first and second spacer arms are formed from a flexible thermoplastic elastomer or a thermoset elastomer.
